(19) United States
(12) Patent Application Publication
(10) Pub. No.: US 2015/0052542 A1
(43) Pub. Date: Feb. 19, 2015

(54) SYSTEM AND METHOD FOR MEASURING MEDIA AUDIENCE

(71) Applicant: IBOPE Pesquisa de Mídia e Participações Ltda., Sao Paulo (BR)

(72) Inventors: Alex Reis dos Santos, Sao Paulo (BR); Eduardo Bernardi, Sao Paulo (BR)

(73) Assignee: IBOPE Pesquisa de Mídia e Participações Ltda., Sao Paulo (BR)

(21) Appl. No.: 14/325,593

(22) Filed: Jul. 8, 2014

(30) Foreign Application Priority Data
Aug. 19, 2013 (BR) 102013021175-3

(51) Int. Cl. H04N 21/442

(52) U.S. Cl. CPC H04N 21/44204; H04N 21/44222
USPC 725/14

(57) ABSTRACT

The present invention relates to a system for measuring media audience, especially for measuring contents broadcast by radio and TV broadcasting stations via land, cable, satellite and otherwise, which comprises at least one local audience measurement device (3) operatively associated to at least one media-content reproducing device (2) and to at least one research and data processing central (4), where the local audience measurement device (3) has means for carrying out local compaction of the program reproduced by the equipment (2) from at least one piece of information sent by the central (4) on the program.

The present invention relates to a system for measuring media audience, especially contents broadcast by radio and television broadcasting stations via land, cable, satellite or otherwise, which enables real-time monitoring of the audience of a given domicile or panelist and requires low information traffic and consequent telecommunication resources, since it makes a comparison of in-home watched or listened-to contents by only contacting the central, and the consequent information traffic via telecommunication network, when the in-home comparison is incapable of identifying the channel watched.

The present invention further relates to a method of measuring audience, carried out by the above mentioned system.

### DESCRIPTION OF THE ART

The number relating to “audience” has various meanings, in general, they relate to the estimates in percentage or absolute numbers of the number of persons, domiciles (or families), media receiving and/or reproducing sets that are exposed or exhibit the contents broadcast by the stations and produced by the respective content producers.

Starting from a small sample of viewers, carefully chosen (on the basis of education, region where one live, family income, race, sex, etc.), one can achieve quite representative audience results, which simulate reliably a whole population.

As far as TV-program audience is concerned, it should be noted that there are, at present, numberless measurement techniques, which employ different measurement systems to detect which channels are being watched by a determined sample of persons, television sets or domiciles.

Generically one can say that the systems known at present for measuring audience are formed by apparatus that resister what is being received on each television set and transmit the registered data to a collection central provided with equipment that interpret what has been registered, identifying which stations were tuned in by each TV set, when and for how long. The estimates of TV-station audiences are made continuously and with the aid of registers especially designed for this purpose.

In order to achieve this, one has to identify the tune-in state (ON/OFF TV and tuned-in station) of the television sets present at a given moment or interval before calculating what portion of the audience goes to one or the other broadcasting station, which can be carried out in the most varied ways, such as detection of the angular position of the channel selector present on old TV sets, the energy of any part of the circuit that is associated to the OFF-TV status, the voltage applied to the variable capacitance diode of the TV receiver, the value of the frequency irradiated by the local oscillating circuit, the interpretation of the commands given to the TV set by monitoring the panel buttons, of the displays and of the information displayed on the screen, etc.

However, although the above-mentioned techniques are much used, they have been replaced by a new tendency that arose in the past decade, which comprises the analysis of the contents of the signals transmitted by the channels. This analysis enables determination of the tune-in state of the TV set by identifying its contents, that is, from the analysis of the information that is being broadcast.

In order to estimate the audiences achieved by using this new concept, suffice it to make sure that the contents, that is, the picture and/or the audio present on each monitored television set has been broadcast by one of the other station, regardless of the process used to achieve this result. In order to simplify the process, the analyzed contents often consist only of pictures or only of audio signal. These processes have reasonable assertiveness, compatible with the quality standard required by the analysts of entertainment industry market.

Even though the concept of measuring audience on the basis of the contents broadcast is more interesting, these systems end up generating an intense traffic of audience information, which are transmitted by telecommunication networks such as fixed-telephone, cellphone networks or even the internet, which end up generating non-negligible costs for the traffic of this information and making the audience measurement service expensive.

Two examples of this technology are the Brazilian patent cases PI0401758 and PI0401757-9 of the same applicant.

Patent application US2012/0011533, in turn, relates to a method and equipment for determining the audience of previously recorded programs. For this purpose, the system makes use of the sniffer technology. It is a more and more widespread to watch a program at a time later than it was broadcast, because with the advent of digital television it is easy to record the program for subsequent watching. The increase of this habit makes it necessary to consider pre-recorded programming for more accuracy of audience results.

The technology disclosed in this document, however, is not capable of comparing the subscriptions generated with those of the channel that was already been watched before in local form, saving telecommunication resources (that is, the telecommunication resources are used in a much higher degree than with the present invention).

Application US2011/0224992 discloses set-to-box equipment having means for encoding or decoding an audio signal, but analogically it does not have the capacity of comparing the subscriptions generated with those of the signal that was been watched before in local form. Thus, this solution spares telecommunication resources.

Finally, application US2011/0108587 discloses an audience measurement system in which one or more audio signals are processed for generating audio subscriptions that are pre-stored. These subscriptions are sent to meters installed at the residences of the panelists according to a predetermined schedule.

After receiving an activation message, the local meters start generating audio subscriptions of the programs that are being watched and carry out a local comparison for determining eventual match. If there is match, the result is sent to the central for subsequent analysis, indicating the channel watched by the panelist.

Even though this system has the capability to make local comparison, it depends upon subscriptions generated at a central prior to broadcasting the program, pre-stored and sent to each meter shortly before the respective programs of those times are broadcast. Therefore, this solution is one that is conceptually quite different from that developed by the applicant now.

### OBJECTIVES OF THE INVENTION

An objective of the present invention is to provide a system for measuring media audience, especially contents broadcast by land, cable, satellite and other TV and radio broadcasting stations, which enable one to monitor in real time the audience of a determined domicile or panelist with low information traffic and consequent telecommunication resources, resulting in a reduction of costs for rendering this service.

A further objective of the present invention is to provide an audience measuring method carried out by the above-described system with low use of telecommunication resources.

### BRIEF DESCRIPTION OF THE INVENTION

The objectives of the present invention are achieved by means of a system for measuring media audience, especially for measuring contents broadcast by land, cable, satellite and other TV and radio broadcasting stations, which comprises at least one local audience measurement device operatively associated to at least one media-content reproducing piece of equipment and to at least one research and data processing central, the local audience device having means to carry out local comparison of the programming reproduced by the equipment from at least one piece of information sent by the central about the programming.

Also, the objectives of the present invention are achieved by means of a method for measuring media audience, especially for measuring contents broadcast by land, cable, satellite and other TV and Radio broadcasting stations, for carrying out an audience measurement system as defined in the preceding paragraph, comprising the following steps:

i) generating, by means of the local audience measurement device, at least one first piece audience information corresponding to the programming reproduced by the equipment from at least one sensor element;
ii) sending said at least one first piece of audience information to the research and data processing central;
iii) processing, at the research and data processing station (4), said at least one first piece of audience information sent at step (ii) and generating at least one second piece of audience information;
iv) sending said at least one second piece of audience information to the local audience measurement device;
v) determining, on the local audience measurement device, the programming that is being reproduced by the equipment from said at least one second piece of audience information;
vi) comparing locally, by means of the local audience measurement device, the programming that is being reproduced by the equipment with said at least one second piece of audience information, carried out with a given frequency while there is result equivalence.

### BRIEF DESCRIPTION OF THE DRAWINGS

The present invention will now be described in greater detail with reference to an example of embodiment represented in the drawings. The figures show:

FIG. 1 is a schematic view of the media audience measurement system of the present invention;

FIG. 2 is a schematic view of the media audience measurement system of the present invention in a first operation situation, when there is use of the telecommunication network;

FIG. 3 is a schematic view of the media audience measurement system of the present invention in a second operation situation, when the local comparison is carried out and the telecommunication network is not used.

### DETAILED DESCRIPTION OF THE FIGURES

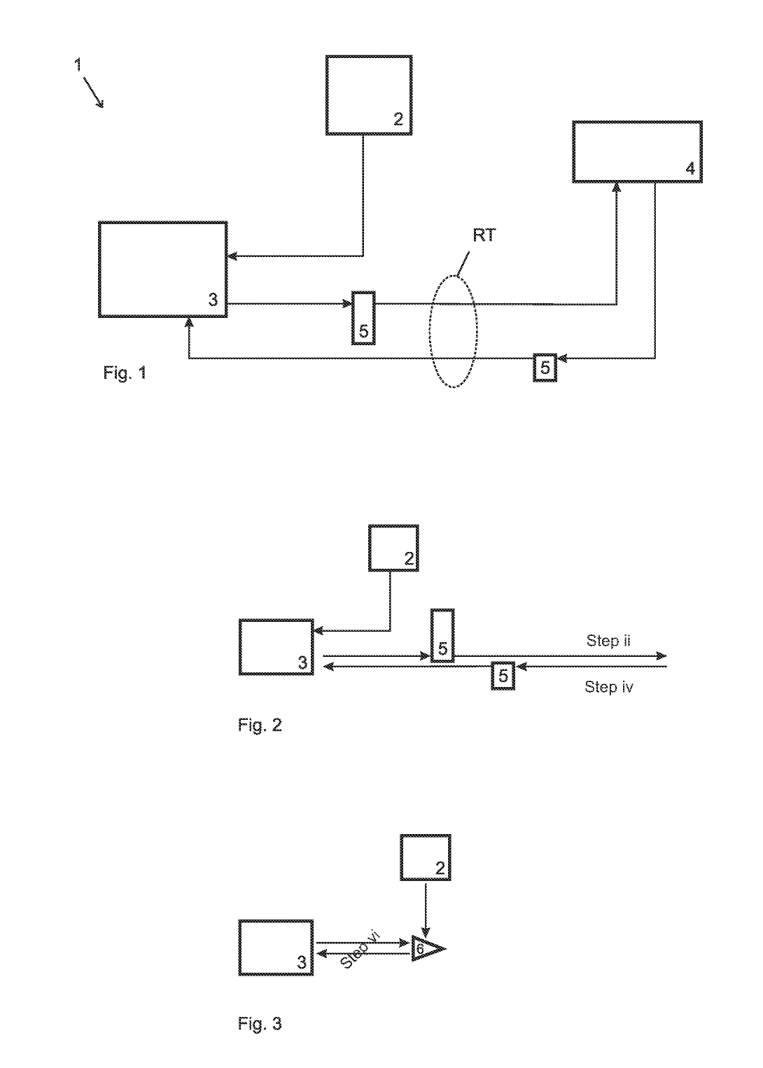

The present media audience measurement system is illustrated schematically in FIG. 1, and its two operation or functioning moments are schematically illustrated in FIGS. 2 and 3.

Essentially describing, the media audience measurement system 1 of the present invention is designed especially for measuring contents broadcast by land, cable, satellite and other radio and TV broadcasting stations. More preferably, the system is indented for measuring the audience of TV programs, but nothing prevents it from being used for any other type of audience measurement, without it being included in the protection scope of the accompanying inventions.

In order to be functional, the system 1 should comprise at least one local audience measurement device 3 operatively associated to at least one media content reproducing equipment 2, such as a TV set, a computer, a handheld, a tablet or still any other, and to at least one research and data processing central.

Preferably, the local audience measurement device 3 takes on the form of set-top-box (stb), but it is evident that it may have another necessary configuration, as long as it has the capability to generate audience information, called also “subscriptions” and that will be described later.

Still in an essential description, it is an imperious characteristic of the present system 1 that the local audience device 3 should have means for making the local comparison of the programming reproduced by the equipment 2 from at least one piece of information sent by the central 4 on the programming.

The research and data processing central 4 is any equipment or set of various pieces of equipment of the local audience device 3 that has means for generating audience information and manages to carry out detection of the programming reproduced by the equipment 2, so as to generate said information on the programming.

Physically speaking, the system 1 comprises at least one local audience device 3, which monitors the media content reproducing equipment 2. In order for an audience raising to have validity, precision and assertiveness, it is important that a determined sample population representative of the total of persons of a given collectivity should be monitored, so that the system 1 will preferably comprise a plurality (dozens, hundreds or even thousands) of local audience devices 3.

Each device 3 is operatively associated to the reproducing equipment 2, but preferably both will be adjacent. Thus, preferably one foresees n samples of viewers, whose audience one desires to monitor and, therefore, n devices 3 operatively associated to reproducing pieces of equipment 2.

Since all and every audience measurement system is based on the reliability and assertiveness of the information obtained, this type of activity is historically performed by companies of unblemished reputation, which must render an assertive service and faithful to reality as much as possible, in order for the results to be accredited by the users thereof.

For this reason, the n samples are monitored so that the audience information obtained will be representative of the group in which the samples are inserted. By way of example, in order to record the audience in a big city, the sample used should represent the population of this place, including people of different regions, social classes and religions, including groups of families of various sizes, each having a varying number of media receiver/reproducers, including media receivers/reproducers of different models and marks, etc., in proportion approaching those in which the respective populations are found.

This plurality of local audience devices 3 (although the figures show only one, for ease of understanding) is operationally associated to at least one central 4. It is evident that there may be a plurality of centrals 4, if one desires, for instance in cites, regions or even countries that are geographically far from each other. Anyway, the number of centrals 4 does not alter at ail the functioning of the present system 1.

As a rule, the operational association between each local audience device 3 and the central 4 is made by means of a telecommunication network (TN/RT), such as a fixed telephone network, cellphones, the Internet or even a dedicated wireless (radiofrequency) network. Any network may be used here without the resulting system failing to be included in the protection scope of the claims.

Further describing the system physically, it should be noted that each local audience device 3 detects the programming reproduced by the equipment 2 by means of at least one sensor element 8, which may be associated to it or even be part of it.

Before characterizing the sensor element 6, it should be noted that, as discussed above, the present audience measurement trend resorts to the analysis of contents of transmitted signals, enabling one to determine the programming reproduced by the equipment 2 by identifying the content thereof, that is, on the basis of the analysis of the information being broadcast.

The essence of the assisted programming content measurement lies ion the fact that it is enough to make sure that the contents (for example, the image and/or audio) present on each equipment 2 monitored has been emitted by one or another broadcasting station, regardless of the process used for achieving this result.

In order to simplify the process, the analyzed contents often consist of only images or only audio signal and in this line, with a view to decreasing transmitted data (and the corresponding costs and time for this purpose), it is usual to compress the contents exhibited by the monitored equipment 2, creating a piece of information and audience that determines “subscription”.

The subscription of a determined content is a compacted piece of information of this content, even when this compaction is so strong that it becomes impossible to return to the original content (compaction with loss). The subscription can be understood as being a “trail” of the content.

Each subscription is a set of values calculated from characteristics and properties extracted from the content of a piece of information. Conventionally, mathematic algorithms are tools used for calculating compact subscriptions (much smaller than the space occupied by the original information).

Therefore, an audio or video signal can be digitalized and transformed into digital information. A subscription of an audio and/or video signal is a compact set of values that are somehow associated to the digital information that represents the original audio and/or video signal. A subscription is extracted from the signal which it represents. On the other hand, as a rule, the compaction is of such magnitude that the signal represented cannot be generated from a subscription.

The great advantage of the audience measurement by monitoring the content, as is the case of the present system 1, further makes it possible to identify the audience, even when it is consumed under demand or has time lag (time shift viewing). In other words, if a determined person records a program X that was broadcast by station A at 3:00 PM and watches it only at 08:00 PM, it will be possible to identify which contents of which station coincides with the subscription(s) generated by the equipment monitored. In this way, even if the program is not watched in real time, there will always be the subscriptions of the station that broadcast that information.

Preferably, the content is drastically compressed before it is transmitted to the central, where it will be compared with the equally compacted contents generated there. In this compaction process, one identifies which stations and when they were tuned in by the TV sets at the monitored places.

However, even though the compaction should be big in order to reduce the number of information bytes (and it is very important for reducing the transmission time and chiefly for decreasing the costs referring to the transmission, since most telecommunication networks charge their services on the basis of the volume of data packets transmitted, regardless of the day or time on or at which the broadcasts are carried out) it must guarantee that the resulting date will be robust all the same. In other words, the compaction may not be so big that it will cause non-identification of the channel watched. Normally, the subscriptions generated have varying sizes that depend on the amount in seconds of the audio that is being analyzed.

Then, the compacted audience data, be they those obtained from the sample or those generated at the station, are the already mentioned subscriptions.

Preferably, for reasons of cost, ease and assertiveness, the sensor element 6 is an audio sensor such as a microphone, which has the capability of transforming sound signals emitted by the equipment 2 into electric signals, even though it is evident that it may have other configurations, such as a camera or image sensor, luminance sensor or still any other necessary or desirable configuration.

In possession of the information about the content of the watched program captured by the sensor element 6, the local audience device 3 has said means for processing this information and generating a first piece of audience/subscription information 5.

The local audience device 3 further has means for sending the first audience information 5 to the research and data processing station 4 and means for receiving at least one second audience information 5′ (which will be described later), send by the research and data processing central 4.

When the system is in operation and the user turns on/off a media-content reproducing equipment 2, the audience of which one desires to monitor, this means that he will watch a given programming and this audience needs to be monitored.

As soon as the equipment 2 is turned on, the sensor element 6 captures audience information such as sounds or images of the program broadcast. The local audience device 3 then generates a first piece of audience information 5 and sends it to the central 4. Concomitantly, the central 4 is generating subscriptions of all the programs being broadcast at that given place and makes a comparison of the subscriptions that it generates uninterruptedly with the first audience information 5 that was sent to it by the device 3. When the comparison is match, the central 4 identifies which program is broadcast by that equipment 2.

From this identification of the match program, the central 4 generates a piece of information on the program that is called second audience information 5′ and that is sent by the central 4 to the device 3.

Thus, summarizing the functioning of the system 1, in order to detect the program watched as soon as the equipment 2 is turned on, the chronology is as follows: the user turns on the equipment 2, which begins to broadcast a program→the sensor 6 of the device 3 captures data of the broadcast program→the device 3 generates at least one first piece of audience information 5→the device 3 sends the first piece of audience information 5 to the central 4→the central 4 processes the first piece of audience information 5, identifies the match program, generates information on the program that is called second audience information 5′ and sends it to the device 3.

From this moment on, the device 3 knows which channel is being tuned in on the equipment 2 and which program is being watched, and here the great innovation of the present system 1 over the prior techniques starts.

The local audience device 3, starting from the second piece of audience information 5′ sent by the central 4, has means for tuning in this station and making a comparison between the program reproduced by the equipment 2.

Preferably, the device 3 has means for comparing the first pieces of audience information 5 themselves that generate the subscriptions that he himself creates from the program tuned in on its tuner, which has tuned on the basis of the second piece of audience information 5′.

Thus, the device 3 monitors locally the equipment 2 comparing the second piece of audience information with the channel watched. This comparison is made from time to time (for instance, every minute or every 30 seconds). Since this monitoring is local, it dispenses with sending information by means of the RT telecommunication network, which reduces the operation cost of the system 1, while the user continues on the same channel, that is, he continues to watch the same program.

The local comparison is made from time to time and, while the user does not change channels, the match occurs. However, when the user changes channel or goes on to another program, the local comparison between the program being watched and the program tuned in locally on the device 3 exhibits a diverging result.

In this case, the device 3 again generates a first piece of audience information 5′, which will be processed at the central and, after identifying the watched channel, the central will send a second piece of audience information 5′ about this new channel. Immediately afterward, the device 3 will tune in this new channel on its tuner and start the local comparison until the user changes channel again, when the central 4 will be actuated again.

Evidently, the central 4 has the capability of communicating with a plurality of devices 3, so that the system 1 will be able to monitor a plurality of domiciles/panelists.

With the present system 1, the RT telecommunication network is used for identifying the tuned-in channel only when the equipment 2 is turned on and then when the user changes channel, reducing the use of the network to the minimum possible. For instance, in case the user watches a 2-hour long film and only changes channel at the end, the device 3 will make the local comparison for two hours, by only adding the central 4 and using the telecommunication network when the channel is changed.

The result is that the operation costs of the system 1 are much reduced in comparison with the present-day systems, which make the measurement of the watched content, rendering its utilization clearly advantageous and without any type of contraindication.

A method for measuring media audience, especially for measuring contents broadcast by land, cable, satellite and otherwise, to be carried out in the above-described audience measurement system is a novel invention exhibiting inventive step. The method comprises the following steps:

(i) generating, by means of the local audience measurement device, at least one first piece audience information corresponding to the programming reproduced by the equipment from at least one sensor element;
(ii) sending said at least one first piece of audience information to the research and data processing central;
(iii) processing, at the research and data processing station (4), said at least one first piece of audience information sent at step (ii) and generating at least one second piece of audience information;
(iv) sending said at least one second piece of audience information to the local audience measurement device;
(v) determining, on the local audience measurement device, the programming that is being reproduced by the equipment from said at least one second piece of audience information;
(vi) comparing locally, by means of the local audience measurement device, the programming that is being reproduced by the equipment with said at least one second piece of audience information, carried out with a given frequency while there is result equivalence.

In the present method, the step (vi) is carried out while there result equivalence and, at the moment when it does not occur any longer, the step (i) starts again.

A preferred example of embodiment having been described, one should understand that the scope of the present invention embraces other possible variations, being limited only by the contents of the accompanying claims, which include the possible equivalents.

1. A system for measuring media audience, especially for measuring contents broadcast by radio and TV broadcasting stations via land, cable, satellite and otherwise, which comprises at least one local audience measurement device (3) operatively associated to at least one media-content reproducing equipment (2) and to at least one research and data processing central (4), the system being characterized in that the local audience device (3) has means for carrying out the local comparison of the program reproduced by the equipment (2) from at least one piece of information sent by the central (4) on the program.

2. The system according to claim 1, characterized in that the local audience measurement device (3) has means for tuning in the media contents broadcast and compare them, locally and in real time, with the program reproduced by the equipment (2).

3. The system according to claim 1, characterized in that the local audience measurement device (3) has means for generating a first piece of audience information (5) and for sending it to the research and data processing central (4).

4. The system according to claim 3, characterized in that the local audience measurement device (3) has means for generating the first piece of audience information (5) from the contents of the program reproduced by the equipment (2).

5. The system according to claim 4, characterized ion that the research and data processing central (4) has means for generating a second piece of audience information (5″) from the processing of the first piece of audience information (5) generated and sent by the local audience measurement device (3).

6. The system according to claim 5, characterized in that the local audience measurement device (3) has means for receiving at least one piece of audience information (5′) sent by the research and data processing central (4).

7. The system according to claim 3, characterized in that the local audience measurement device (3) generates the first piece of audience information (5) from at least one sensor clement (6) that captures sounds and/or images from the program reproduced by the equipment (2).

8. A method for measuring media audience, especially for measuring contents broadcast by radio and TV broadcasting stations via land, cable, satellite and otherwise, to be carried out in an audience measurement system as defined in claim 1, characterized by comprising the following steps:
i—generating, by means of the local audience measurement device (3), at least one first piece of information (5) corresponding to the program reproduced by the equipment (2), from said at least one sensor element (6);
ii—sending said at least one first piece of audience information (5) to the research and data processing central (4);
iii—processing, at the research data processing central (4), said at least one first piece of audience information (5) sent at step (ii) and generating at least one second piece of audience information (5′);
iv—sending said at least one second piece of audience information (5′) to the local audience measurement device from said at least one second audience information (5′);
vi—comparing locally, by means of the local audience measurement device (3), the program that is being reproduced by the equipment (2), with said at least one second audience information (5′), carried out with a given frequency while there is equivalence result.

9. The method according to claim 8, characterized in that the step (vi) is carried out while there is result equivalence and, at the moment when it ceases to exist, the step (i) begins again.
